(19) United States
(12) Patent Application Publication
(10) Pub. No.: US 2023/0123797 A1
(43) Pub. Date: Apr. 20, 2023

(54) METHOD FOR PRODUCING POLYHYDROXYALKANOATE AND USE OF SAME

(71) Applicant: KANEKA CORPORATION, Osaka-shi (JP)

(72) Inventor: Masaru HIRANO, Takasago-shi (JP)

(73) Assignee: KANEKA CORPORATION, Osaka-shi (JP)

(21) Appl. No.: 17/759,876

(22) PCT Filed: Jan. 19, 2021
(86) PCT No.: PCT/JP2021/001579

§ 371 Date: Aug. 1, 2022

(30) Foreign Application Priority Data
Feb. 12, 2020 (JP) 2020-021678

(51) Int. Cl. C08G 63/89; C08G 63/06

(52) U.S. Cl. CPC C08G 63/89; C08G 63/06

(57) ABSTRACT

A method for producing a polyhydroxyalkanoate, the method including: (a) preparing an aqueous polyhydroxyalkanoate suspension having a pH of not more than 5; (b) mixing the aqueous suspension obtained in (a) with a water-insoluble organic solvent having a specific gravity of more than 1.0 g/mL; (c) separating a mixed solution obtained in (b) into a water-insoluble organic solvent phase and an aqueous phase by centrifugal separation, and then removing the aqueous phase; and (d) heating the water-insoluble organic solvent phase obtained in (c), and then cooling the water-insoluble organic solvent phase to obtain a gelatinous polyhydroxyalkanoate.

### TECHNICAL FIELD

The present invention relates to a method for producing a polyhydroxyalkanoate and use thereof.

### BACKGROUND ART

Polyhydroxyalkanoates (hereinafter, may be referred to as “PHAs”) are known to have biodegradability.

PHAs, which are produced by microorganisms, are accumulated within cells of the microorganisms. As such, in order to use a PHA as a plastic, a step of separating the PHA from a cell of a microorganism and refining the PHA is required. The step of separating and refining a PHA involves crushing a cell of a PHA-containing microorganism or solubilizing an organism-derived component other than a PHA, and then taking out the PHA from an obtained aqueous suspension. In so doing, a separating operation, e.g., centrifugal separation, filtration, drying, or the like, is carried out. In a drying operation, a spray dryer, a fluidized-bed dryer, a drum dryer, or the like is used, and a spray dryer is preferably used because it is easy to operate (Patent Literature 1).

### CITATION LIST

### Patent Literature

[Patent Literature 1]
PCT international application publication, No. WO2018/070492

### SUMMARY OF INVENTION

### Technical Problem

However, spray drying has room for improvement.

The object of the present invention is to provide, as an alternative to spray drying, a production method which make it possible to obtain a PHA with a simple operation and at a high yield.

### Solution to Problem

As a result of conducting diligent studies in order to attain the above object, the inventor of the present invention newly found it possible to easily obtain a PHA at a high yield by mixing an aqueous PHA suspension having a specific pH with a specific water-insoluble organic solvent and then separating an obtained mixed solution into a water-insoluble organic solvent phase and an aqueous phase by centrifugal separation. As a result, the inventor of the present invention completed the present invention.

Therefore, an aspect of the present invention relates to a method for producing a PHA, the method including the steps of: (a) preparing an aqueous PHA suspension having a pH of not more than 5; (b) mixing the aqueous suspension obtained in the step (a) with a water-insoluble organic solvent having a specific gravity of more than 1.0 g/mL; (c) separating a mixed solution obtained in the step (b) into a water-insoluble organic solvent phase and an aqueous phase by centrifugal separation, and then removing the aqueous phase; and (d) heating the water-insoluble organic solvent phase obtained in the step (c), and then cooling the water-insoluble organic solvent phase to obtain a gelatinous PHA.

Further, an aspect of the present invention relates to a polyhydroxyalkanoate aggregate containing: a polyhydroxyalkanoate; and a water-insoluble organic solvent having a specific gravity of more than 1.0 g/mL.

### Advantageous Effects of Invention

According to an aspect of the present invention, it is possible to obtain a PHA with a simple operation and at a high yield.

### BRIEF DESCRIPTION OF DRAWINGS

FIG. 1 is a schematic view illustrating separated phases which are obtained as a result of centrifugal separation, in accordance with an embodiment of the present invention.

FIG. 2 is a drawing illustrating a PHA aggregate in accordance with an embodiment of the present invention.

### DESCRIPTION OF EMBODIMENTS

The following description will discuss embodiments of the present invention in detail. Unless otherwise specified in this specification, a numerical range expressed as “A to B” means “not less than A and not more than B.” All documents listed herein are incorporated herein by reference.

[1. Outline of an Embodiment of the Present Invention]

A method for producing a PHA (hereinafter, referred to as “present production method”) in accordance with an embodiment of the present invention is a method including the steps of: (a) preparing an aqueous PHA suspension having a pH of not more than 5; (b) mixing the aqueous suspension obtained in the step (a) with a water-insoluble organic solvent having a specific gravity of more than 1.0 g/mL; (c) separating a mixed solution obtained in the step (b) into a water-insoluble organic solvent phase and an aqueous phase by centrifugal separation, and then removing the aqueous phase; and (d) heating the water-insoluble organic solvent phase obtained in the step (c), and then cooling the water-insoluble organic solvent phase to obtain a gelatinous PHA.

The inventor of the present invention considered that, in a case where spray drying is carried out in production of a PHA, there are the following problems. For example, in a spray drying operation, it is necessary to evaporate all water contained in an aqueous suspension. This requires enormous thermal energy. Furthermore, a spray dryer used in the spray drying operation tends to be large in size. This causes a problem that a large area is required to install facilities. Under the circumstances, the inventor of the present invention aimed to develop an alternative to spray drying and conducted diligent studies. As a result, the inventor of the present invention succeeded in obtaining the following findings.
When an aqueous PHA suspension having a specific pH (e.g., not more than 5) is brought into contact with a specific water-insoluble organic solvent (e.g., a water-insoluble organic solvent having a specific gravity of more than 1.0 g/mL), the compatibility of a PHA with the water-insoluble organic solvent is increased.
When the PHA is moved from the aqueous PHA suspension to the specific water-insoluble organic solvent, a mixed solution of the aqueous PHA suspension and the specific water-insoluble organic solvent is separated into a water-insoluble organic solvent phase and an aqueous phase by centrifugal separation. This makes it possible to easily remove an upper phase (aqueous phase), and possible to obtain the water-insoluble organic solvent phase which contains a high yield of PHA.
When the water-insoluble organic solvent phase which has been obtained as a result of the centrifugal separation and which contains the PHA is heated, the PHA contained in the water-insoluble organic solvent phase aggregate by thermal fusion.
When a solution which contains the PHA that has aggregated and which has been heated is cooled, a gelatinous PHA (hereinafter, may be referred to as “gelatinized PHA”) is obtained.
By washing and then drying the obtained gelatinized PHA, a PHA aggregate is obtained. The PHA aggregate is easy to handle, as compared with a PHA powder which is obtained by a spray drying step.

The present invention was completed based on the above findings. Therefore, since the present production method makes it possible to obtain a PHA with a simple operation and at a high yield, the present production method is extremely advantageous in production of a PHA. The present production method will be described below in detail.

[2. Method for Producing PHA]

The present production method includes the following steps (a) to (d) as essential steps.
Step (a): a step of preparing an aqueous PHA suspension having a pH of not more than 5.
Step (b): a step of mixing the aqueous suspension obtained in the step (a) with a water-insoluble organic solvent having a specific gravity of more than 1.0 g/mL.
Step (c): a step of separating a mixed solution obtained in the step (b) into a water-insoluble organic solvent phase and an aqueous phase by centrifugal separation, and then removing the aqueous phase.
Step (d): a step of heating the water-insoluble organic solvent phase obtained in the step (c), and then cooling the water-insoluble organic solvent phase to obtain a gelatinous PHA.

(Step (a))

In the step (a) of the present production method, an aqueous PHA suspension having a pH of not more than 5 is prepared. In the aqueous suspension, a PHA is present in a state of being dispersed in an aqueous medium. Hereinafter, an aqueous suspension containing at least a PHA may be abbreviated to “aqueous PHA suspension”.

<PHA>

In this specification, the term “PHA” is a generic term for polymers in each of which a monomer unit is a hydroxyalkanoic acid. A hydroxyalkanoic acid which is a constituent of the PHA is not particularly limited, and examples thereof include lactic acid, 3-hydroxybutanoic acid, 4-hydroxybutanoic acid, 3-hydroxypropionic acid, 3-hydroxypentanoic acid, 3-hydroxyhexanoic acid, 3-hydroxyheptanoic acid, and 3-hydroxyoctanoic acid. The polymers can be homopolymers or copolymers each of which contains two or more types of monomer units.

More specifically, examples of the PHA include polylactic acid, poly(3-hydroxybutyrate) (P3HB), poly(3-hydroxybutyrate-co-3-hydroxyhexanoate) (P3HB3HH), poly(3-hydroxybutyrate-co-3-hydroxyvalerate) (P3HB3HV), poly(3-hydroxybutyrate-co-4-hydroxybutyrate) (P3HB4HB), poly(3-hydroxybutyrate-co-3-hydroxyoctanoate) (P3HB3HO), poly(3-hydroxybutyrate-co-3-hydroxyoctadecanoate) (P3HB3HOD), poly(3-hydroxybutyrate-co-3-hydroxydecanoate) (P3HB3HD), and poly(3-hydroxybutyrate-co-3-hydroxyvalerate-co-3-hydroxyhexanoate) (P3HB3HV3HH). Among these examples, P3HB, P3HB3HH, P3HB3HV, and P3HB4HB are preferable because they are easy to industrially produce.

Further, P3HB3HH, which is a copolymer of 3-hydroxybutyric acid and 3-hydroxyhexanoic acid, is more preferable from the following viewpoints: (i) by changing a composition ratio of repeating units, it is possible to cause a change in melting point and crystallinity and consequently in physical properties, such as a Young's modulus and heat resistance, of P3HB3HH and to enable P3HB3HH to have physical properties between the physical properties of polypropylene and the physical properties of polyethylene; and (ii) P3HB3HH is a plastic that is easy to industrially produce as described above and has useful physical properties.

In an embodiment of the present invention, a composition ratio of repeating units in P3HB3HH is such that a composition ratio of a 3-hydroxybutyrate unit to a 3-hydroxyhexanoate unit is preferably 80/20 (mol/mol) to 99/1 (mol/mol), and more preferably 85/15 (mol/mol) to 97/3 (mol/mol), from the viewpoint of a balance between plasticity and strength. In a case where the composition ratio of the 3-hydroxybutyrate unit to the 3-hydroxyhexanoate unit is not more than 99/1 (mol/mol), sufficient plasticity is obtained. In a case where the composition ratio is not less than 80/20 (mol/mol), sufficient hardness is obtained.

In the step (a), the aqueous PHA suspension, which is used as a starting material, is not particularly limited, and can be obtained, for example, by a method including a culturing step of culturing a microorganism capable of producing the PHA within a cell of the microorganism and a refining step of decomposing and/or removing a substance other than the PHA after the culture step.

The present production method can include, before the step (a), a step of obtaining the aqueous PHA suspension (for example, a step including the culturing step and the refining step described above). A microorganism used in this step is not particularly limited, provided that the microorganism is capable of producing the PHA within a cell of the microorganism. For example, it is possible to use a microorganism isolated from nature, a microorganism deposited at a depositary institution (for example, IFO, ATCC, or the like) for strains, or a mutant, a transformant, or the like that can be prepared from any of those microorganisms. More specific examples of the microorganism include bacteria of the genera Cupriavidus, Alcaligenes, Ralstonia, Pseudomonas, Bacillus, Azotobacter, Nocardia, and Aeromonas. Among these examples, the microorganism is preferably a microorganism belonging to the genus Aeromonas, Alcaligenes, Ralstonia, or Cupriavidus. In particular, the microorganism is more preferably a strain of A. lipolytica, A. latus, A. caviae, A. hydrophila, C. necator, or the like, and most preferably C. necator.

In a case where the microorganism is one that is inherently not capable of producing a PHA or one that produces only a small amount of a PHA, a transformant obtained by introducing, into the microorganism, a gene of an enzyme that synthesizes an intended PHA and/or a variant of the gene can be also used. The gene of such a PHA synthetase used to prepare the transformant is not particularly limited, but is preferably a gene of a PHA synthetase derived from A. caviae. By culturing these microorganisms under appropriate conditions, it is possible to obtain cells of the microorganisms having PHAs accumulated within the cells. A method of culturing a cell of the microorganism is not particularly limited, and can be a method described in, for example, Japanese Patent Application Publication Tokukaihei No. 05-93049.

A PHA-containing microorganism prepared by culturing the above microorganism contains a large amount of microbial cell-derived components, which are impurities. As such, ordinarily, the refining step can be carried out in order to decompose and/or remove the impurities other than the PHA. The refining step is not particularly limited, and any physical treatment, any chemical treatment, any biological treatment, or the like that can be arrived at by a person skilled in the art can be employed. For example, a refining method described in International Publication No. WO 2010/067543 is suitably employed.

The amount of the impurities which are to remain in an end product is substantially determined by the above refining step. As such, it is preferable to minimize the impurities. Of course, depending on the purpose of use, it may be acceptable to have the impurities mixed in the end product, provided that the physical properties of the end product are not impaired. However, in a case where a highly pure PHA is required, for example, for medical use, it is preferable to minimize the impurities. In so doing, an index of a degree of refinement can be, for example, the amount of protein contained in the aqueous PHA suspension. The amount of the protein is preferably not more than 30000 ppm, more preferably not more than 15000 ppm, even more preferably not more than 10000 ppm, and most preferably not more than 7500 ppm per weight of the PHA. A refining means is not particularly limited, and can be, for example, the foregoing publicly known method.

Note that a solvent (the “solvent” may be referred to also as “aqueous medium”) contained in the aqueous PHA suspension in the present production method may be water or a mixed solvent of water and an organic solvent. In the mixed solvent, the concentration of the organic solvent, which is compatible with water, is not particularly limited, provided that the concentration is equal to or lower than the solubility, in water, of the organic solvent used. The organic solvent compatible with water is not particularly limited, and examples thereof include: alcohols such as methanol, ethanol, 1-propanol, 2-propanol, 1-butanol, 2-butanol, iso-butanol, pentanol, hexanol, and heptanol; ketones such as acetone and methyl ethyl ketone; ethers such as tetrahydrofuran and dioxane; nitriles such as acetonitrile and propionitrile; amides such as dimethylformamide and acetamide; dimethyl sulfoxide; pyridine; and piperidine. Among these examples, methanol, ethanol, 1-propanol, 2-propanol, 1-butanol, 2-butanol, iso-butanol, acetone, methyl ethyl ketone, tetrahydrofuran, dioxane, acetonitrile, propionitrile, and the like are preferable as the organic solvent compatible with water, because they are easy to remove. As the organic solvent compatible with water, methanol, ethanol, 1-propanol, 2-propanol, butanol, acetone, and the like are more preferable, because they are easy to obtain. As the organic solvent compatible with water, methanol, ethanol, and acetone are particularly preferable. Note that the aqueous medium contained in the aqueous PHA suspension may contain another solvent, a microbial cell-derived component, a compound which is generated during refinement, and/or the like, provided that the essentials of the present invention are not impaired.

The aqueous medium contained in the aqueous PHA suspension in the present production method preferably contains water. The amount of water contained in the aqueous medium is preferably not less than 50% by weight, more preferably not less than 60% by weight, even more preferably not less than 70% by weight, and particularly preferably not less than 80% by weight.

<Others>

The aqueous PHA suspension that has not been subjected to the step (a) of the present production method ordinarily has a pH of more than 7 by being subjected to the above refining step. As such, by the step (a) of the present production method, the pH of the aqueous PHA suspension is adjusted to not more than 5. A method of adjusting the pH is not particularly limited. For example, the pH can be adjusted by adding an acid. The acid is not particularly limited, and may be an organic acid or an inorganic acid. The acid may or may not be volatile. More specifically, examples of the acid include sulfuric acid, hydrochloric acid, phosphoric acid, and acetic acid.

The upper limit of the pH of the aqueous PHA suspension which is adjusted in the above adjusting step is not more than 5, preferably not more than 4, and more preferably not more than 3, from the viewpoint of the compatibility of the PHA with a water-insoluble organic solvent in the step (b). The lower limit of the pH is preferably not less than 1, more preferably not less than 1.2, and even more preferably not less than 1.4, from the viewpoint of the acid resistance of a container. In a case where the pH of the aqueous PHA suspension is not more than 5, the PHA is sufficiently dissolved in the water-insoluble organic solvent in the step (b). This consequently makes it possible to collect the PHA at a high yield.

Note that Patent Literature 1 also discloses, in a technique which is disclosed in Patent Literature 1 and in which a spray drying step is carried out, adjusting the pH of an aqueous PHA suspension to not more than 7. However, this adjustment is carried out in order to reduce coloring of a PHA during heating and melting and to prevent a decrease in molecular weight of the PHA during heating and/or drying. In contrast, in the present production method, the pH is adjusted to not more than 5 in order to promote movement of the PHA from the aqueous PHA suspension to a water-insoluble organic solvent phase (as described later in Comparative Examples, in a case where the pH of the aqueous PHA suspension is more than 5, the efficiency of the movement of the PHA to the water-insoluble organic solvent phase is extremely low). Thus, it is added, just in case, that the technique disclosed in Patent Literature 1 and the present production method greatly differ from each other in the purpose of reducing the pH of the aqueous PHA suspension.

The concentration of the PHA contained in the aqueous PHA suspension obtained by the step (a) of the present production method is preferably not less than 30% by weight, more preferably not less than 40% by weight, and even more preferably not less than 50% by weight, from the viewpoint of (i) an economical advantage in terms of utility in drying and (ii) a resultant improvement in productivity. The upper limit of the concentration of the PHA is preferably not more than 65% by weight, and more preferably not more than 60% by weight, because, otherwise, it may not be possible to ensure sufficient flowability due to closest packing. A method of adjusting the concentration of the PHA is not particularly limited. For example, the concentration can be adjusted by adding an aqueous medium or by removing part of the aqueous medium (e.g., by centrifugal separation followed by removal of a supernatant). Adjustment of the concentration of the PHA may be carried out at any stage in the step (a) or may be carried out prior to the step (a).

(Step (b))

In the step (b) of the present production method, the aqueous suspension obtained in the step (a) is mixed with a water-insoluble organic solvent having a specific gravity of more than 1.0 g/mL.

The water-insoluble organic solvent used in the step (b) is not particularly limited, provided that the water-insoluble organic solvent has a specific gravity of more than 1.0 g/mL. In a case where the specific gravity of the water-insoluble organic solvent is more than 1.0 g/mL, it is possible to separate an obtained mixed solution into an aqueous phase, which forms an upper phase in a centrifuge tube, and a water-insoluble organic solvent phase, which forms a lower phase (bottom-side phase) in the centrifuge tube, when the mixed solution is subjected to centrifugal separation in the step (c) (described later).

In an embodiment of the present invention, examples of the water-insoluble organic solvent having a specific gravity of more than 1.0 g/mL include triacetin, dimethyl carbonate, tripropionin, propylene glycol diacetate, and tributyrin. The water-insoluble organic solvent having a specific gravity of more than 1.0 g/mL is preferably triacetin, dimethyl carbonate, and/or tripropionin, and more preferably triacetin and/or tripropionin, from the viewpoint of a difference in specific gravity from water and easiness of centrifugal separation.

In an embodiment of the present invention, the water-insoluble organic solvent having a specific gravity of more than 1.0 g/mL can be at least one selected from the group consisting of triacetin, dimethyl carbonate, tripropionin, propylene glycol diacetate, and tributyrin.

Further, in an embodiment of the present invention, the specific gravity of the water-insoluble organic solvent is preferably not higher than the specific gravity of the PHA. This makes it possible to cause the water-insoluble organic solvent phase, which contains the PHA, to be the lowest layer, and accordingly makes it possible to easily collect the PHA. Note that the specific gravity of the PHA is 1.2 g/mL.

In an embodiment of the present invention, the solubility of the water-insoluble organic solvent in water is, for example, not more than 18 g/100 mL, preferably not more than 17 g/100 mL, more preferably not more than 16 g/100 mL, and particularly preferably not more than 15 g/100 mL, at 20° C. to 40° C. In a case where the solubility of the water-insoluble organic solvent in water is not more than 18 g/100 mL, it is possible to sufficiently separate the water-insoluble organic solvent phase and the aqueous phase when the mixed solution is subjected to centrifugal separation in the step (c) (described later). The lower limit of the solubility of the water-insoluble organic solvent in water is not particularly limited, and is, for example, not less than 0.1 g/100 mL.

Note that the specific gravity and the solubility, in water, of each of triacetin, dimethyl carbonate, tripropionin, propylene glycol diacetate, and tributyrin are as follows. ⋅ Triacetin: 1.16 g/mL (specific gravity), 6.1 g/100 mL (solubility in water at 25° C.)
Dimethyl carbonate: 1.07 g/mL (specific gravity), 13.9 g/100 mL (solubility in water at 25° C.)
Tripropionin: 1.08 g/mL (specific gravity), 0.3 g/100 mL (solubility in water at 37° C.)
Propylene glycol diacetate: 1.06 g/mL (specific gravity), 9.0 g/100 mL (solubility in water at 25° C.)
Tributyrin: 1.03 g/mL (specific gravity), 0.13 g/100 mL (solubility in water at 37° C.)

(Step (c))

In the step (c) of the present production method, a mixed solution obtained in the step (b) is separated into a water-insoluble organic solvent phase and an aqueous phase by centrifugal separation, and then the aqueous phase is removed.

In the step (c), the centrifugal separation can be carried out by any method publicly known in the present technical field. For example, the centrifugal separation can be carried out with use of a centrifuge Allegra™ X-22R manufactured by Beckman Coulter, Inc. (described later in Examples). A rotational speed, time, and the like of the centrifugal separation can be set as appropriate by a person skilled in the art.

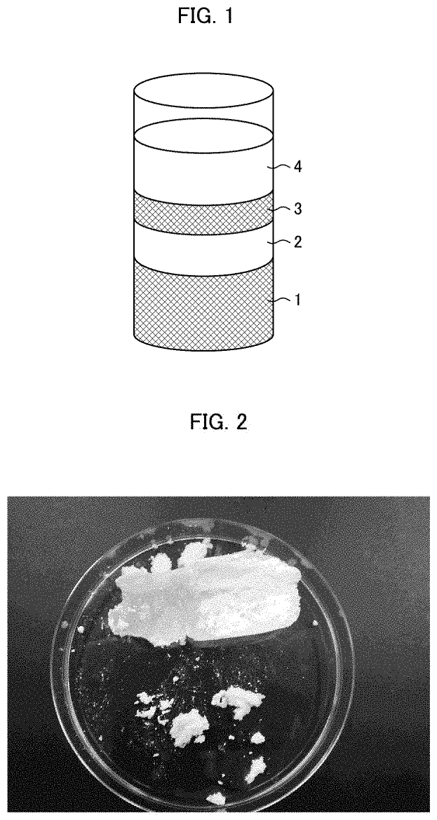

A separated state which is obtained as a result of the centrifugal separation in the step (c) in an embodiment of the present invention will be described below with reference to FIG. 1. After the centrifugal separation in the step (c), the mixed solution is separated into a PHA phase A1, a water-insoluble organic solvent main component phase 2, a PHA phase B3, and a water main component phase 4 in this order from a bottom (the bottom of the centrifuge tube). The PHA phase A1 is a mixed solution mainly containing the PHA and the water-insoluble organic solvent. In the PHA phase A1, the PHA is most concentrated. The PHA phase A1 may partially contain a component other than the PHA. The water-insoluble organic solvent main component phase 2 is a solution mainly containing the water-insoluble organic solvent. The water-insoluble organic solvent main component phase 2 may partially contain the PHA and a component other than the PHA. The PHA phase B3 is a mixed solution mainly containing the PHA and water. The PHA phase B3 can contain the PHA which has not settled in the water-insoluble organic solvent phase. The PHA phase B3 may contain a component other than the PHA. The water main component phase 4 is a phase mainly containing water, and may partially contain the PHA and a component other than the PHA.

Note that, in this specification, a PHA phase A and a water-insoluble organic solvent main component phase may be collectively referred to simply as “water-insoluble organic solvent phase”. Note also that, in this specification, a PHA phase B and a water main component phase may be collectively referred to simply as “aqueous phase”.

By employing the present production method, it is possible to obtain the PHA at a high yield. Note, here, that the yield of the PHA in the step (c) can be indicated by an index a value of which is expressed by the following Expression (1):

volume of PHA phase A/(volume of PHA phase A+volume of PHA phase B)×100 (1).

In an embodiment of the present invention, the value expressed by the above Expression (1) is, for example, not less than 45%, preferably not less than 48%, and more preferably not less than 50%. Note that the “volume of PHA phase A” and the “volume of PHA phase B” are measured by a method described in Examples.

(Step (d))

In the step (d) of the present production method, the water-insoluble organic solvent phase obtained in the step (c) is heated and then cooled to obtain a gelatinous PHA.

In the step (d), when the water-insoluble organic solvent phase is heated, the PHA contained in the water-insoluble organic solvent phase fuse together by heat, so that the PHA which has aggregated is obtained.

In an embodiment of the present invention, a heating temperature in the step (d) is not particularly limited, provided that such a PHA aggregate is obtained by thermal fusion. For example, the heating temperature is 50° C. to 150° C., and preferably 60° C. to 130° C.

A heating method in the step (d) is not particularly limited, and, for example, a method in which an oil bath is used can be employed. Moreover, heating time is also not particularly limited, and can be set as appropriate by a person skilled in the art.

In the step (d), by cooling a solution containing the PHA which has been obtained by the heating and which has aggregated, the PHA is gelatinized, so that a gelatinous PHA is obtained. It can be said that the gelatinous PHA contains the PHA and the water-insoluble organic solvent.

In an embodiment of the present invention, a cooling temperature in the step (d) is not particularly limited, provided that the gelatinized PHA is obtained. For example, the cooling temperature is lower than 50° C., preferably not higher than 40° C., not higher than 30° C., not higher than 25° C., not higher than 20° C., and not higher than 15° C.

A cooling method in the step (d) is not particularly limited, and, for example, a method in which water cooling is carried out can be employed. Moreover, cooling time is also not particularly limited, and can be set as appropriate by a person skilled in the art.

(Others)

The present production method can include, after the step (d), the following step (e):

(e) washing, with an organic solvent, the gelatinous polyhydroxyalkanoate obtained in the step (d), and then drying the gelatinous polyhydroxyalkanoate to obtain a polyhydroxyalkanoate aggregate.

By the step (e), it is possible to obtain a PHA aggregate in which the PHA has aggregated. The PHA aggregate is a massive PHA, and has a particle size larger than that of a powdery PHA which is obtained by a spray drying step. Thus, the PHA aggregate is easy to handle.

In an embodiment of the present invention, the organic solvent used to wash the gelatinous PHA is not particularly limited, and examples thereof include isopropanol, ethanol, tert-butanol, methanol, acetone, and hexane. Washing with use of the organic solvent in the step (e) can be carried out by any method publicly known in the present technical field.

In an embodiment of the present invention, a drying method is not particularly limited, and drying can be carried out by any method publicly known in the present technical field. Examples of the drying method include hot air drying and vacuum drying.

[3. PHA Aggregate]

A PHA aggregate in accordance with an embodiment of the present invention (hereinafter, referred to as “present PHA aggregate”) contains a PHA and a water-insoluble organic solvent having a specific gravity of more than 1.0 g/mL.

The present PHA aggregate is produced by the present production method. Therefore, the present PHA aggregate has an advantage of being obtained with a simple operation and at a high yield.

The present PHA aggregate contains a water-insoluble organic solvent having a specific gravity of more than 1.0 g/mL. The amount of the water-insoluble organic solvent contained in the present PHA aggregate is not particularly limited, and is, for example, 0.01 parts by weight to 10 parts by weight, and preferably 0.01 parts by weight to 1 part by weight with respect to 100 parts by weight of the PHA contained in the present PHA aggregate. In a case where the amount of the water-insoluble organic solvent falls within the above range, the present PHA aggregate has an advantage of having reduced flammability.

The size of the present PHA aggregate is not particularly limited, and is, for example, such that the maximum diameter is preferably 0.1 cm to 10 cm, more preferably 0.5 cm to 9.0 cm, and even more preferably 1.0 cm to 8.0 cm. In a case where the size falls within such a range, the present PHA aggregate is excellent in terms of operability.

The present PHA aggregate may contain various components which have been produced or have not been removed during the present production method, provided that an effect of the present invention is brought about.

Note that the description given in the above [2. Method for producing PHA] applies to the matters which have not been particularly described in the present embodiment.

The present PHA aggregate can be used for various applications such as paper, films, sheets, tubes, plates, rods, containers (e.g., bottle containers and the like), bags, and parts.

The present invention is not limited to the embodiments, but can be altered by a skilled person in the art within the scope of the claims. The present invention also encompasses, in its technical scope, any embodiment derived by combining technical means disclosed in differing embodiments.

Namely, the present invention encompasses the following embodiments.

<1> A method for producing a polyhydroxyalkanoate, including the steps of:

(a) preparing an aqueous polyhydroxyalkanoate suspension having a pH of not more than 5;

(b) mixing the aqueous suspension obtained in the step (a) with a water-insoluble organic solvent having a specific gravity of more than 1.0 g/mL;

(c) separating a mixed solution obtained in the step (b) into a water-insoluble organic solvent phase and an aqueous phase by centrifugal separation, and then removing the aqueous phase; and

(d) heating the water-insoluble organic solvent phase obtained in the step (c), and then cooling the water-insoluble organic solvent phase to obtain a gelatinous polyhydroxyalkanoate.

<2> The method as described in <1>, further including the step of (e) washing, with an organic solvent, the gelatinous polyhydroxyalkanoate obtained in the step (d), and then drying the gelatinous polyhydroxyalkanoate to obtain a polyhydroxyalkanoate aggregate.
<3>

The method as described in <1> or <2>, wherein the step (c) includes a step of separating the mixed solution into a polyhydroxyalkanoate phase A, a water-insoluble organic solvent main component phase, a polyhydroxyalkanoate phase B, and a water main component phase in this order from a bottom, and removing the polyhydroxyalkanoate phase B and the water main component phase.

<4> The method as described in any one of <1> to <3>, wherein, in the step (c), a value expressed by the following Expression (1) is not less than 45%:

volume of polyhydroxyalkanoate phase A/(volume of polyhydroxyalkanoate phase A+volume of polyhydroxyalkanoate phase B)×100 (1).

<5> The method as described in any one of <1> to <4>, wherein the water-insoluble organic solvent is at least one selected from the group consisting of triacetin, dimethyl carbonate, tripropionin, propylene glycol diacetate, and tributyrin.
<6> The method as described in any one of <1> to <5>, wherein a heating temperature in the step (d) is 50° C. to 150° C.
<7> The method as described in any one of <1> to <6>, wherein a cooling temperature in the step (d) is lower than 50° C.
<8> A polyhydroxyalkanoate aggregate including: a polyhydroxyalkanoate; and a water-insoluble organic solvent having a specific gravity of more than 1.0 g/mL.

### EXAMPLES

The following description will discuss embodiments of the present invention in further detail on the basis of Examples. Note, however, that the present invention is not limited to Examples.

### Example 1

(Preparation of Microbial Cell Culture Solution)

Ralstonia eutropha KNK-005 strain described in paragraph [0049] of International Publication No. WO 2008/010296 was cultured by a method described in paragraphs [0050] to [0053] of the same document to obtain a microbial cell culture solution containing microbial cells containing a PHA. Note that Ralstonia eutropha is currently classified as Cupriavidus necator.

(Sterilization)

The obtained microbial cell culture solution was sterilized by heating and stirring it at an internal temperature of 60° C. to 80° C. for 20 minutes.

(High-Pressure Crushing)

To the sterilized microbial cell culture solution thus obtained, 0.2% by weight of sodium dodecyl sulfate was added. An aqueous sodium hydroxide solution was further added so that a pH of 11.0 was achieved, and then an obtained solution was kept at 50° C. for 1 hour. Then, the solution was subjected to high-pressure crushing at a pressure of 450 kgf/cm² to 550 kgf/cm² with use of a high-pressure crusher (a high-pressure homogenizer, model PA2K, manufactured by Niro-Soavi).

(Refinement)

To the crushed solution which had been obtained as a result of the high-pressure crushing, distilled water was added in an amount equivalent to the crushed solution. An obtained solution was subjected to centrifugal separation, and then a supernatant was removed. As a result, an aqueous suspension which had been obtained by adding the distilled water was twice concentrated. To the aqueous suspension of the PHA which had been obtained by such concentration, an aqueous sodium hydroxide solution (pH: 11.0) was added in an amount equal to that of the removed supernatant. A suspension which had been obtained by adding the aqueous sodium hydroxide solution was then subjected to centrifugal separation. Subsequently, a supernatant was removed, water was added again, and then suspension was carried out. Then, 0.2% by weight of sodium dodecyl sulfate and protease (Esperase, manufactured by Novozymes) in an amount of 1/100th of the weight of the PHA were added. A suspension which had been obtained by adding the sodium dodecyl sulfate and the protease was stirred for 2 hours while being kept at pH 10.0 and 50° C. The suspension which had been stirred was then subjected to centrifugal separation, and a supernatant was removed. As a result, the suspension which had been obtained by adding the sodium dodecyl sulfate and the protease was four times concentrated. To the suspension which had been obtained by such concentration, water was added so that the concentration of the PHA was adjusted to 52% by weight.

(Centrifugal Separation)

Sulfuric acid was added to an aqueous PHA suspension which had been obtained by the foregoing method, and the pH was adjusted until the pH was stabilized at 4.0. Subsequently, 35.0 g of triacetin (specific gravity: 1.16 g/mL) and 12.5 g of the aqueous PHA suspension were introduced into a 50 mL centrifuge tube, and then mixed. An obtained mixed solution was subject to centrifugal separation at a rotational speed of 4000 rpm for 30 minutes with use of a centrifuge Allegra™ X-22R manufactured by Beckman Coulter, Inc. After the centrifugal separation, the mixed solution was separated into a PHA phase A, a water-insoluble organic solvent main component phase, a PHA phase B, and a water main component phase in this order from a bottom of the centrifuge tube.

The volume of each phase which had been obtained as a result of the centrifugal separation was measured with use of a volumetric scale of the centrifuge tube. Thereafter, on the basis of the measured volume of the PHA phase A and the measured volume of the PHA phase B, a PHA collection rate was calculated with use of Expression (1) below. Table 1 shows the volume of each phase and the PHA collection rate.

PHA collection rate=volume of PHA phase A/(volume of PHA phase A+volume of PHA phase B)×100 (1)

The PHA phase B and the water main component phase were removed from the mixed solution which had been subjected to the centrifugal separation, and consequently a PHA-containing water-insoluble organic solvent suspension (in Examples, “PHA-containing triacetin suspension”) was obtained. Subsequently, the PHA-containing triacetin suspension was heated at 130° C. for 5 minutes, and then cooled at a room temperature so that the PHA was gelatinized. The gelatinized PHA was filtered and collected, washed with isopropanol, and then dried to obtain a PHA aggregate. The PHA aggregate is illustrated in FIG. 2.

The PHA aggregate had a size (maximum diameter) of 6.4 cm.

### Example 2

A mixed solution containing a PHA was subjected to centrifugal separation in the same manner as in Example 1, except that sulfuric acid was added to an aqueous PHA suspension and a pH was adjusted until the pH was stabilized at 4.7. Table 1 shows a PHA collection rate. A PHA aggregate had a size (maximum diameter) of 6.1 cm.

### Example 3

A mixed solution containing a PHA was subjected to centrifugal separation in the same manner as in Example 1, except that sulfuric acid was added to an aqueous PHA suspension and a pH was adjusted until the pH was stabilized at 2.7. Table 1 shows a PHA collection rate. A PHA aggregate had a size (maximum diameter) of 5.8 cm.

### Example 4

A mixed solution containing a PHA was subjected to centrifugal separation in the same manner as in Example 3, except that the amount of triacetin was changed to 25.0 g and the amount of an aqueous PHA suspension was changed to 22.5 g. Table 1 shows a PHA collection rate. A PHA aggregate had a size (maximum diameter) of 6.4 cm.

### Example 5

A mixed solution containing a PHA was subjected to centrifugal separation in the same manner as in Example 1, except that sulfuric acid was added to an aqueous PHA suspension and a pH was adjusted until the pH was stabilized at 1.5. Table 1 shows a PHA collection rate. A PHA aggregate had a size (maximum diameter) of 7.6 cm.

### Example 6

A mixed solution containing a PHA was subjected to centrifugal separation in the same manner as in Example 5, except that the amount of triacetin was changed to 25.0 g and the amount of an aqueous PHA suspension was changed to 22.5 g. Table 1 shows a PHA collection rate. A PHA aggregate had a size (maximum diameter) of 6.3 cm.

### Example 7

A mixed solution containing a PHA was subjected to centrifugal separation in the same manner as in Example 5, except that the amount of triacetin was changed to 17.5 g and the amount of an aqueous PHA suspension was changed to 30.4 g. Table 1 shows a PHA collection rate. A PHA aggregate had a size (maximum diameter) of 6.1 cm.

### Comparative Example 1

A mixed solution containing a PHA was subjected to centrifugal separation in the same manner as in Example 1, except that sulfuric acid was added to an aqueous PHA suspension and a pH was adjusted until the pH was stabilized at 8.3. Table 1 shows a PHA collection rate. A PHA aggregate had a size (maximum diameter) of 3.1 cm.

### Comparative Example 2

A mixed solution containing a PHA was subjected to centrifugal separation in the same manner as in Example 1, except that sulfuric acid was added to an aqueous PHA suspension and a pH was adjusted until the pH was stabilized at 7.0. Table 1 shows a PHA collection rate. A PHA aggregate had a size (maximum diameter) of 4.6 cm.

### Comparative Example 3

A mixed solution containing a PHA was subjected to centrifugal separation in the same manner as in Example 1, except that sulfuric acid was added to an aqueous PHA suspension and a pH was adjusted until the pH was stabilized at 5.9. Table 1 shows a PHA collection rate. A PHA aggregate had a size (maximum diameter) of 5.3 cm.

TABLE 1

| | | | | After centrifugal separation | | | | |
|---|---|---|---|---|---|---|---|---|
| | | | | | Water- | | | |
| | | | | | insoluble | | | |
| | Before centrifugal separation | | | | organic | | Water | |
| | Aqueous | Aqueous | | PHA | solvent | PHA | main | PHA |
| | PHA | PHA | | phase | main | phase | component | collection |
| | suspension | suspension | Triacetin | A | component | B | phase | rate |
| | pH | [g] | [g] | [mL] | phase [mL] | [mL] | [mL] | [%] |
| Example 1 | 4.0 | 12.5 | 35.0 | 11.8 | 21.9 | 2.6 | 1.9 | 82 |
| Example 2 | 4.7 | 12.5 | 35.0 | 9.5 | 23.0 | 7.5 | 0.0 | 56 |
| Example 3 | 2.7 | 12.5 | 35.0 | 11.1 | 24.4 | 1.1 | 5.3 | 91 |
| Example 4 | 2.7 | 22.5 | 25.0 | 22.5 | 8.6 | 2.2 | 8.7 | 91 |
| Example 5 | 1.5 | 12.5 | 35.0 | 11.1 | 24.4 | 2.8 | 2.8 | 80 |
| Example 6 | 1.5 | 22.5 | 25.0 | 21.7 | 8.9 | 2.5 | 8.6 | 90 |
| Example 7 | 1.5 | 30.4 | 17.5 | 28.3 | 1.1 | 0.3 | 12.8 | 99 |
| Comparative | 8.3 | 12.5 | 35.0 | 4.0 | 23.5 | 13.5 | 0.0 | 23 |
| Example 1 | | | | | | | | |
| Comparative | 7.0 | 12.5 | 35.0 | 5.0 | 21.7 | 15.0 | 0.0 | 25 |
| Example 2 | | | | | | | | |
| Comparative | 5.9 | 12.5 | 35.0 | 8.5 | 20.4 | 12.8 | 0.0 | 40 |
| Example 3 | | | | | | | | |

[Results]

As is clear from Table 1, the PHA collection rates in Examples 1 to 7 were higher than those in Comparative Examples 1 to 3. That is, it was found that the PHA collection rates in Examples 1 to 7 were higher than those in Comparative Examples 1 to 3, in each of which the pH was more than 5.

Furthermore, from FIG. 2, it was found possible to collect the PHA aggregates from the aqueous PHA suspensions by using the methods in Examples (i.e., the method in accordance with an embodiment of the present invention).

### INDUSTRIAL APPLICABILITY

Since the present production method makes it possible to produce a PHA with a simple operation and at a high yield, the present production method is advantageously used in production of a PHA. Further, a PHA aggregate and the like obtained by the present production method can be suitably used in the fields of agriculture, fishing, forestry, horticulture, medicine, sanitary products, clothing, non-clothing, packaging, automobiles, building materials, and the like.

### REFERENCE SIGNS LIST

1 Polyhydroxyalkanoate phase A (PHA phase A)
2 Water-insoluble organic solvent main component phase
3 Polyhydroxyalkanoate phase B (PHB phase B)
4 Water main component phase

1. A method for producing a polyhydroxyalkanoate, comprising:
(a) preparing an aqueous polyhydroxyalkanoate suspension having a pH of not more than 5;
(b) mixing the aqueous suspension obtained in (a) with a water-insoluble organic solvent having a specific gravity of more than 1.0 g/mL, thereby obtaining a mixed solution;
(c) separating the mixed solution obtained in (b) into a water-insoluble organic solvent phase and an aqueous phase by centrifugal separation, and then removing the aqueous phase; and
(d) heating the water-insoluble organic solvent phase obtained in (c), and then cooling the water-insoluble organic solvent phase to obtain a gelatinous polyhydroxyalkanoate.

2. The method of claim 1, further comprising:
(e) washing, with an organic solvent, the gelatinous polyhydroxyalkanoate obtained in (d), and then drying the gelatinous polyhydroxyalkanoate to obtain a polyhydroxyalkanoate aggregate.

3. The method of claim 1, wherein the separating in (c) includes separating the mixed solution into a polyhydroxyalkanoate phase A, a water-insoluble organic solvent main component phase, a polyhydroxyalkanoate phase B, and a water main component phase in this order from a bottom, and removing the polyhydroxyalkanoate phase B and the water main component phase.

4. The method of claim 3, wherein, in (c), a value expressed by the following Expression (1) is not less than 45%:
volume of polyhydroxyalkanoate phase A/(volume of polyhydroxyalkanoate phase A+volume of polyhydroxyalkanoate phase B)×100 (1).

5. The method of claim 1, wherein the water-insoluble organic solvent is at least one selected from the group consisting of triacetin, dimethyl carbonate, tripropionin, propylene glycol diacetate, and tributyrin.

6. The method of claim 1, wherein a heating temperature in (d) is 50° C. to 150° C.

7. The method of claim 1, wherein a cooling temperature in (d) is lower than 50° C.

8. A polyhydroxyalkanoate aggregate comprising:
a polyhydroxyalkanoate; and
a water-insoluble organic solvent having a specific gravity of more than 1.0 g/mL.

9. The polyhydroxyalkanoate aggregate of claim 8, wherein the water-insoluble organic solvent is at least one selected from the group consisting of triacetin, dimethyl carbonate, tripropionin, propylene glycol diacetate, and tributyrin.

10. The method of claim 1, wherein the aqueous polyhydroxyalkanoate suspension in (a) comprises an aqueous medium and at least one polyhydroxyalkanoate selected from the group consisting of poly(3-hydroxybutyrate) (P3HB), poly(3-hydroxybutyrate-co-3-hydroxyhexanoate) (P3HB3HH), poly(3-hydroxybutyrate-co hydroxyvalerate) (P3HB3HV), poly(3-hydroxybutyrate-co-4-hydroxybutyrate) (P3HB4HB).

11. The method of claim 1, wherein the aqueous polyhydroxyalkanoate suspension in (a) has a pH of not more than 3.

12. The method of claim 1, wherein the aqueous polyhydroxyalkanoate suspension in (a) has a pH of 1.4 to 3.

13. The method of claim 1, wherein aqueous polyhydroxyalkanoate suspension in (a) comprises from 30% by weight to 65% by weight of a polyhydroxyalkanoate.

14. The method of claim 4, wherein the value expressed by the Expression (1) is not less than 50%.

15. The method of claim 1, wherein a heating temperature in (d) is 60° C. to 130° C.

16. The method of claim 1, wherein a cooling temperature in (d) is 30° C. or less.

17. The method of claim 2, wherein the organic solvent in (e) is selected from the group consisting of isopropanol, ethanol, tert-butanol, methanol, acetone, and hexane.

18. The method of claim 2, wherein the polyhydroxyalkanoate aggregate obtained in (e) has a maximum diameter of from 0.1 cm to 10 cm.

19. The polyhydroxyalkanoate aggregate of claim 8, wherein the polyhydroxyalkanoate aggregate has a maximum diameter of 0.1 cm to 10 cm.

20. The polyhydroxyalkanoate aggregate of claim 8, wherein the polyhydroxyalkanoate aggregate has a maximum diameter of 1.0 cm to 8.0 cm.
